(19) United States
(12) Patent Application Publication
(10) Pub. No.: US 2022/0389952 A1
(43) Pub. Date: Dec. 8, 2022

(54) BOLT RETENTION DEVICE

(71) Applicant: ATF, INC., Lincolnwood, IL (US)

(72) Inventor: Viral Varshney, Buffalo Grove, IL (US)

(73) Assignee: ATF, INC., Lincolnwood, IL (US)

(21) Appl. No.: 17/805,529

(22) Filed: Jun. 6, 2022

Related U.S. Application Data
(60) Provisional application No. 63/202,321, filed on Jun. 7, 2021.

(51) Int. Cl. F16B 39/10

(52) U.S. Cl. CPC F16B 39/105

(57) ABSTRACT

A bolt retention device is provided that includes a bolt having a shaft, a retention portion that includes a radial retention surface extending along the shaft, a sleeve having a cylindrical base with an inner bore, and at least one rib extending radially from the cylindrical base, wherein the retention portion has a diameter sized to receive the inner bore of the sleeve, and wherein the bolt is inserted into the sleeve to align the retention portion with the inner bore of the sleeve. The sleeve works to retain the bolt in a coupling aperture by applying a resistive force in the direction opposite the direction of motion. This resistive force is caused by physical interference created by the ribs against the inner bore of the coupling aperture. The ribs may vary in shape to create different desirable resistive characteristics.

### CROSS REFERENCE TO RELATED APPLICATIONS

This patent application is based on and claims the benefit of and priority to U.S. Provisional Patent Application Ser. No. 63/202,321 filed on Jun. 7, 2021, which is incorporated by reference herein in its entirety for all purposes.

### FIELD OF THE INVENTION

The present invention relates generally to the field of bolt retention. More particularly, the invention relates to a bolt retention device.

### BACKGROUND

Bolt retention devices can assist with securing a bolt to a component prior to assembly of two components. In some applications, bolt retention devices can be utilized for drive shaft and half shaft coupling connections. The bolt is inserted in the coupling (slip-fit by hand or press-fit via pneumatic force). Once inserted, the coupling along with the complete drive shaft assembly is shipped to a customer. The bolt retention device must ensure that the bolt is retained in the coupling through handling, movement, and transit. After the coupling is provided to an assembly line, the bolt is finally secured in a threaded hole or with a nut during final assembly with another component.

Prior bolt retention solutions include polymer material sprayed on a bolt, unfortunately application of such material is difficult to control and once sprayed on the material tends to tear and shred during assembly, leading to bolt retention failure. Another known solution is a lobed polymer sleeve that is installed over the threaded shaft of the bolt and then inserted with the bolt into the coupling. As the polymer sleeve can slide off the bolt, since it floats (moves axially along the length of the shaft) over the shaft of the bolt, the bolt can easily be pushed out of the polymer sleeve, leaving just the polymer sleeve retained in the coupling hole.

### SUMMARY

In at least some embodiments, a bolt retention device is provided that includes: a bolt having a shaft; a retention portion that includes a radial retention surface extending along the shaft; a sleeve having a cylindrical base with an inner bore; and at least one rib extending radially from the cylindrical base, wherein the retention portion has a diameter sized to receive the inner bore of the sleeve, and wherein the bolt is inserted into the sleeve to align the retention portion with the inner bore of the sleeve.

In at least some other embodiments, a bolt retention device is provided that includes: a bolt having a bolt head and a shaft including threads; a retention portion formed along the shaft; and a sleeve insertable over the shaft of the bolt to rest at least partially on the retention portion of the bolt, the sleeve further comprising, a first rib with a gradual linear ramp portion, a second rib with a steep linear ramp portion, a third rib with a non-linear ramp portion, and a gap in the axial direction configured to allow the sleeve to deform and expand outwardly when under force so as to permit assembly, wherein the ribs are separated from one another by a portion of constant sleeve diameter, and wherein the sleeve is insertable into a coupling aperture of a component and each rib provides a resistive force when a removal force is applied to the bolt.

It will be understood by those skilled in the art that one or more aspects of this invention can meet certain objectives, while one or more other aspects can lead to certain other objectives. Other objects, features, benefits, and advantages of the invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### DETAILED DESCRIPTION OF THE DRAWINGS

Embodiments of the invention are disclosed with reference to the accompanying drawings and are for illustrative purposes only. The invention is not limited in application to the details of construction, or the arrangement of the components illustrated in the drawings. The invention is capable of other embodiments or of being practiced or carried out in other various ways.

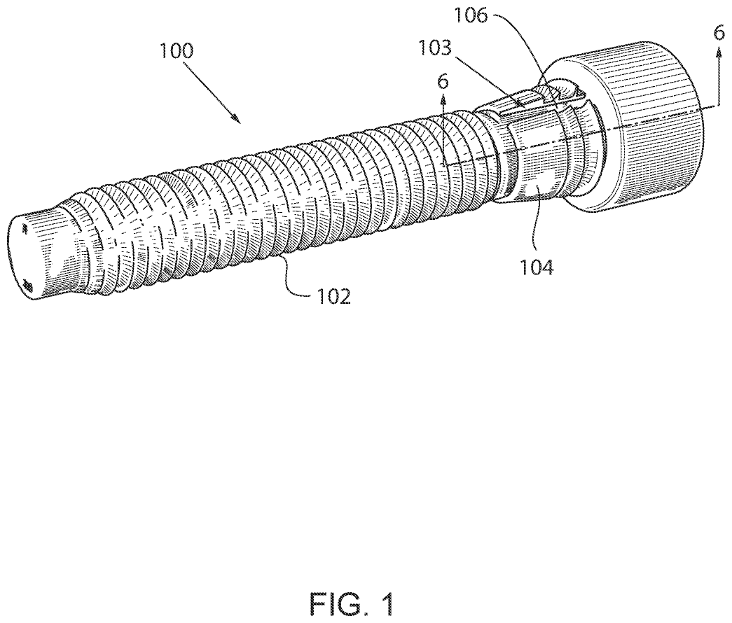

FIG. 1 is an exemplary embodiment of a bolt retention device.

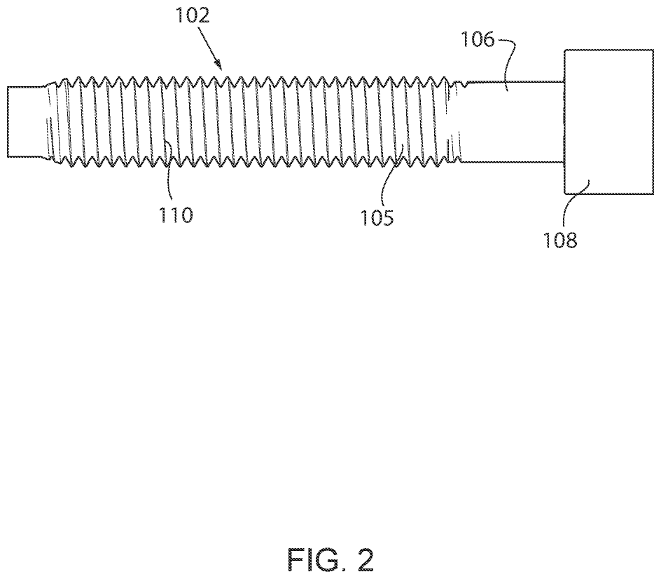

FIG. 2 is an exemplary embodiment of the bolt of FIG. 1 with a retention surface along the shaft to retain a first embodiment of the sleeve of FIG. 1.

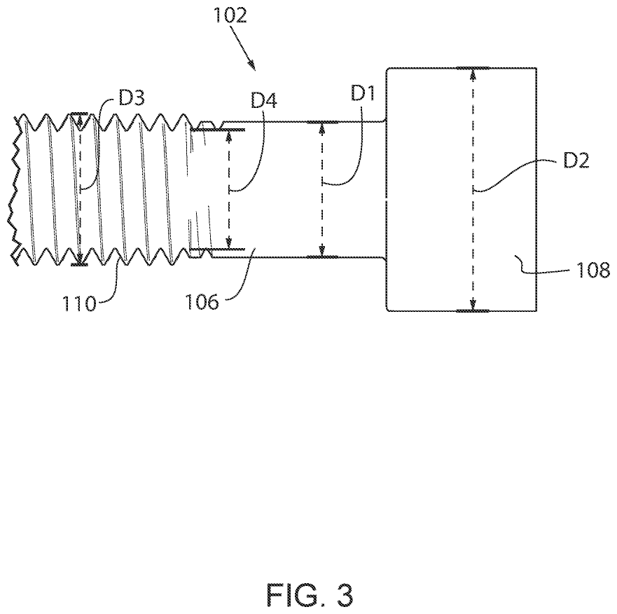

FIG. 3 is a close-up partial view of the bolt of FIG. 2.

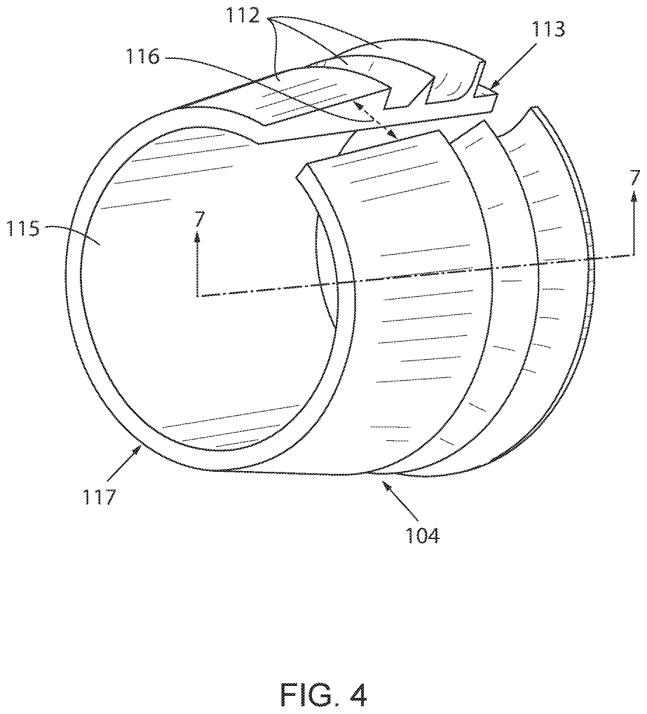

FIG. 4 is a perspective view of a first exemplary embodiment of the sleeve.

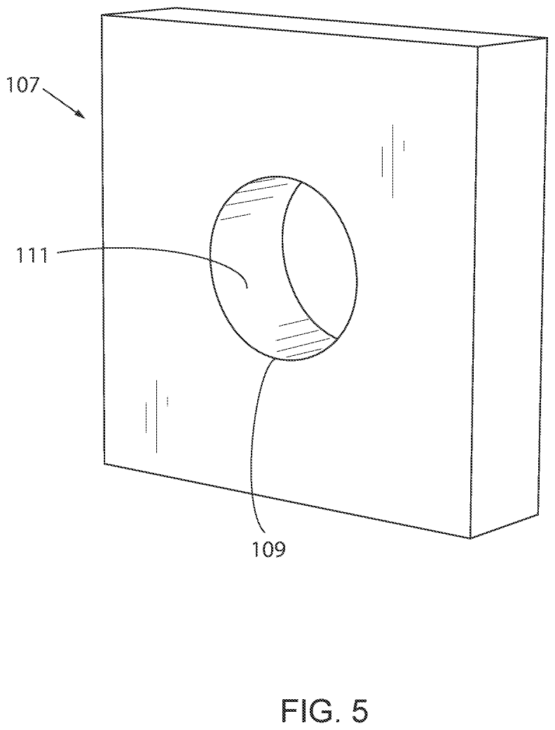

FIG. 5 is a perspective view of an illustrative portion of an exemplary component with a coupling aperture.

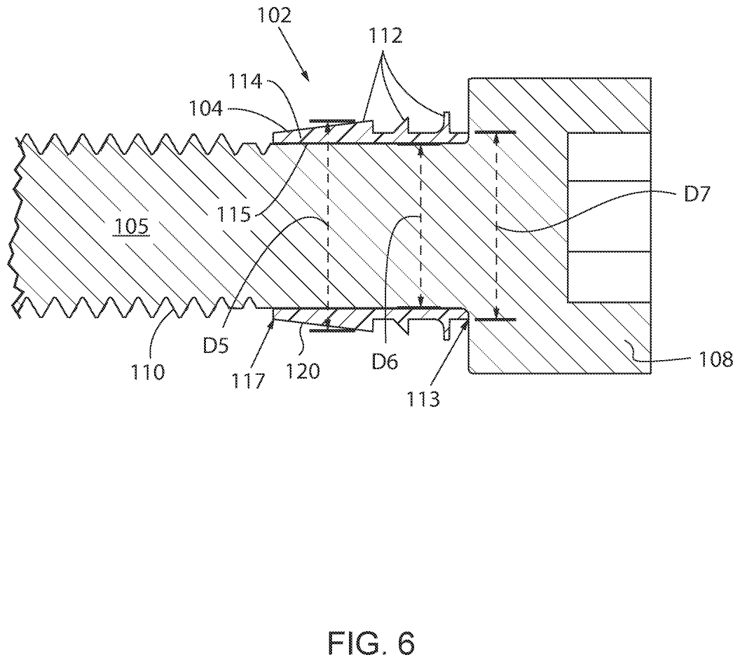

FIG. 6 is a cross-section side view taken along lines 6-6 of FIG. 1 of the bolt of FIG. 2 with the sleeve of FIG. 4 installed.

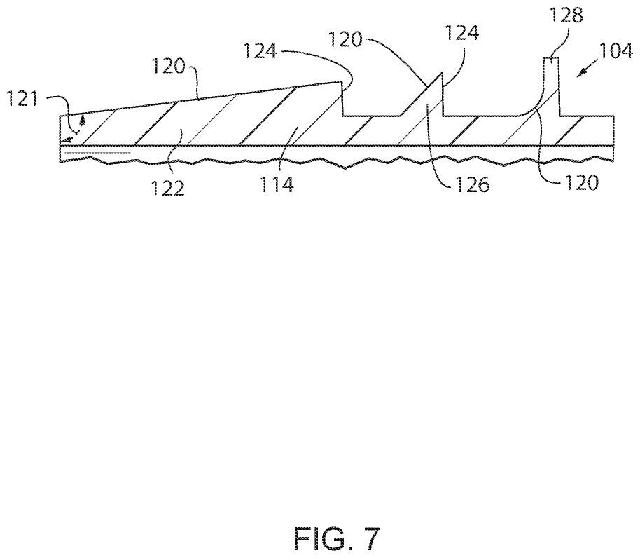

FIG. 7 is a cross-section side view of a portion of the sleeve taken along lines 7-7 of FIG. 4.

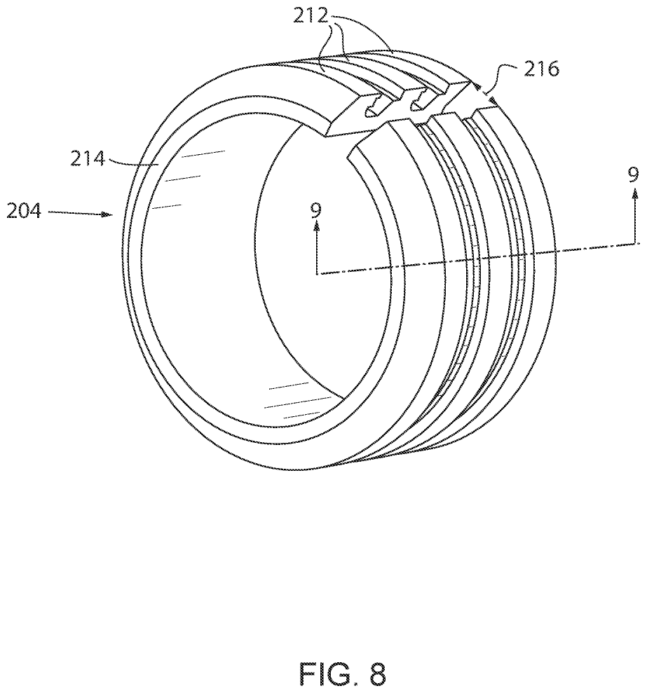

FIG. 8 is a perspective view of a second exemplary embodiment of a sleeve.

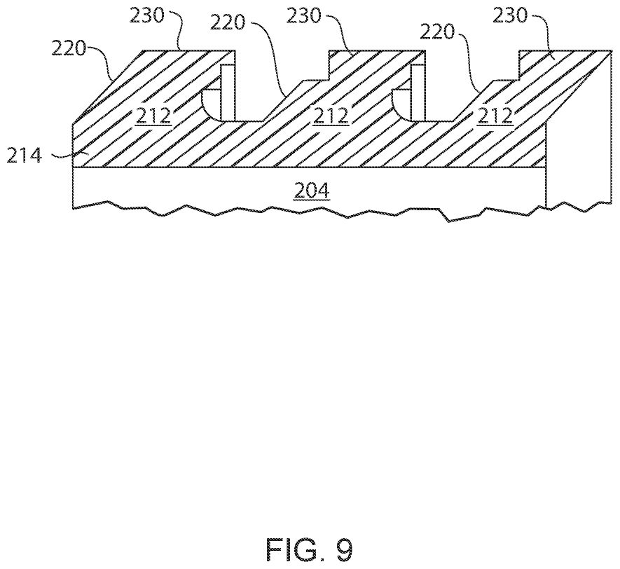

FIG. 9 is a cross-section side view of a portion of the sleeve taken along lines 9-9 of FIG. 8.

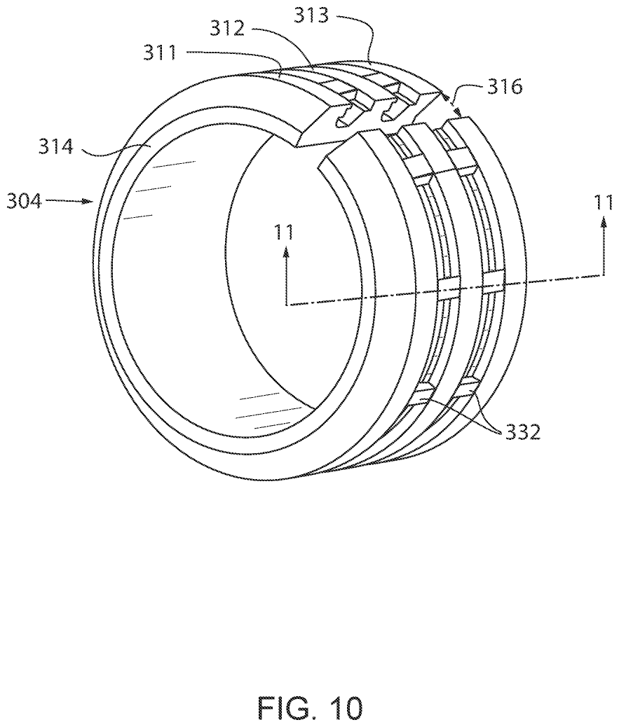

FIG. 10 is a perspective view of a third exemplary embodiment of a sleeve.

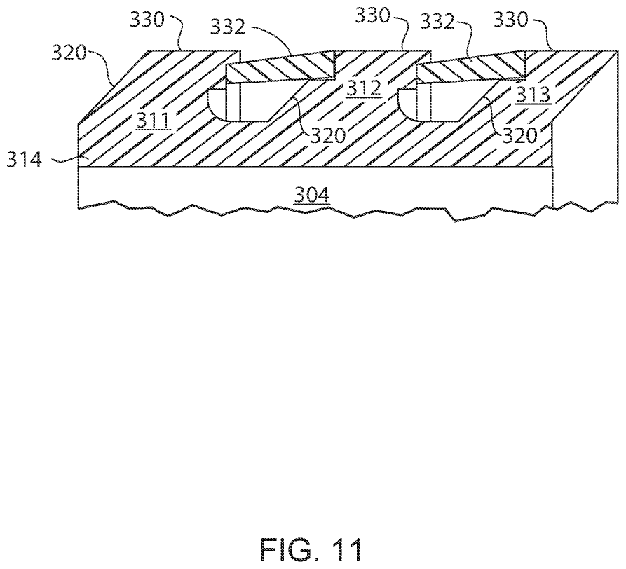

FIG. 11 is a cross-section side view of a portion of the sleeve taken along lines 11-11 of FIG. 10.

### DETAILED DESCRIPTION

FIG. 1 depicts an exemplary embodiment of a bolt retention device 100, including an exemplary bolt 102 having a retention portion 103 that includes a retention surface 106 along the bolt 102, the retention portion 103 configured to receive and secure a first exemplary sleeve 104. As shown in FIGS. 2 and 3, in at least some embodiments, the bolt 102 is designed with a machined or formed retention surface 106 along a shaft 105 and a bolt head 108, the retention surface 106 having a defined geometry and location. The bolt 102 also includes bolt threads 110 along the shaft 105. The location of the retention surface 106 can be selected based on use requirements for the final retention position of the bolt 102. The geometry of the retention portion 103 may include a defined diameter and length in the axial direction. The diameter of the retention portion 103 may be chosen by the required strength for the bolt 102, noting that a smaller diameter will generally reduce its rated strength. As shown with further clarity in FIG. 3, in some embodiments, the diameter of the retention portion (labeled “D1” in FIG. 3) is less than the diameter of the bolt head 108 (labeled “D2”) and less than the outer diameter of the bolt threads (labeled “D3”), but greater than the inner diameter of the bolt threads (labeled “D4”). This will allow the sleeve 104 to rest between the bolt head 108 and the bolt threads 110 without for example, lowering the overall strength of the bolt 102. In some embodiments the diameter of the retention portion 103 is smaller than the inner thread diameter of the bolt 102, creating a thinner neck. Further, in at least some embodiments, the retention portion 103 can be formed along the shaft 105 with a diameter that is larger, smaller, or the same as the diameter of other portions of the shaft 105.

In addition, the sleeve 104 can be designed for a section on the shaft 105 where it is bound on either side with a diameter larger than the diameter of the inner bore of the sleeve 104. For example, using certain manufacturing techniques (i.e., cold rolling) to form the threads 110, the sleeve 104 may be positioned on the retention portion 103 of the bolt 102 before the threads 110 are formed. Here, the sleeve 104 is secured on the retention portion 103 by the bolt head 108 and the newly formed thread outer diameter D3, which is now greater than the diameter of the retention portion D1. The length of the retention portion 103 can be chosen based on various criteria, such as a minimal removal force requirement, as a longer retention portion 103 will allow for a longer sleeve 104, which can allow for a higher force to remove the bolt 102 from the retained location.

FIG. 4 is a perspective view of the first exemplary sleeve 104 that includes a series of ribs 112 extending radially from a cylindrical base 114 having a cylindrical inner bore 115. Once the sleeve 104 is installed on the bolt 102 by passing the sleeve 104 over the shaft 105 of the bolt 102, the cylindrical base 114 will fit at least partially on the retention portion 103, such that the retention portion 103 prevents the sleeve 104 from moving axially along the shaft 105. In at least some embodiments, the sleeve is expandable to allow the sleeve 104 to fit over a bolt feature (i.e. the threads 110 or bolt head 108) during installation. This may be accomplished by using an elastic material allowing the sleeve 104 to deform during installation and then return, at least partially, to its original shape, or by mechanical means. As shown in FIG. 4, to permit this deformation the sleeve 104 may include a longitudinal gap 116 (i.e., a non-continuous portion), formed by a slit or cut in the axial direction extending through the cylindrical base 114 and the series of ribs 112 as a mechanical means of expansion. The gap 116 allows the sleeve 104 to expand to fit over the threaded section of a bolt 102 during installation without damaging the sleeve 104, wherein the gap 116 can vary in size and length as desired or necessary.

For illustrative purposes, FIG. 5 depicts an illustrative portion of an exemplary component 107 with a coupling aperture 109 formed therein, wherein the component 107 can include any of one of various prior art components to which a bolt is to be coupled, such as a coupling of a drive shaft, etc. The coupling aperture 109 includes an inner coupling aperture surface 111, which is depicted as smooth as is known in prior art components, but in at least some embodiments, it may contain various novel features such as ridges, or notches that interact with the ribs 112 of the sleeve 104 in different ways including to increase or decrease the removal force necessary to dislodge the bolt 102 from the coupling aperture 109, wherein the ridges or notches are sized and shaped to engage the ribs 112.

A cross sectional view of the sleeve 104 and the bolt 102 is depicted in FIG. 6 showing ribs 112 extending radially outward. The number of ribs 112, their spacing, and their shape can be varied as desired, depending on the particular application. In at least some embodiments, the shape of the individual ribs 112 an include a ramp portion 120 that extends outward from the base 114 towards an outer rib diameter D5, wherein the ramp portions 120 and outer rib diameters (e.g., D5) can be identical or different between one or more ribs 112 (as shown in FIGS. 4, and 6-7). Varying the outer rib diameter D5 and steepness of the ramp portion 120 can for example, provide an increase or decrease in the force required for installation and removal as noted below.

Now referencing FIGS. 5 and 6 in combination, during insertion of the bolt 102 and sleeve 104 assembly into the coupling aperture 109 of the component 107, the sleeve 104 engages the coupling aperture 109 via the ribs 112 that flex opposite the direction of movement of the bolt 102—during insertion, the ribs 112 flex in a relative axial direction towards a sleeve first end 113 towards the bolt head 108 (along the ramped portions) and during application of removal force from movement, impact or handling, the ribs 112 deflect in a relative axial direction towards a second end 117 (away from the bolt head 108). As the ribs 112 are designed in such a way that the movement due to the removal force causes the ribs 112 to deflect away from the bolt head 108, where each additional rib 112 compounds the resistive force by increasing the overall radial interference in the coupling aperture 109 thus causing a gradual increase in the removal force required to remove the retained bolt 102 as the bolt 102 is pushed out further. This is particularly of benefit to bolt retention since most impact or handling forces are applied in-shock. In a prior art example, when such an event occurs and the peak force required to remove the bolt is achieved, a coupled bolt can easily fall out as the resistive force required for removal is low. In contrast, with the bolt retention device 100, the ribs 112 provide multiple levels of force, which can be increased as desired, such that that multiple low peak force events or a single large force event are necessary to remove the bolt 102 from the coupling aperture 109 of the component 107.

In at least some embodiments, the sleeve 104 is made from a pliable material, such as a polymer, plastic, resin, softer metal alloys, or any other sufficiently pliable material, with defined strength properties that allow for the sleeve 104 to be assembled on the bolt 102 or inserted in the coupling aperture 109 where the bolt 102 is to be retained, and provide the desired removal force (amount of force required to remove the bolt 102 from the retained position). The sleeve 104 design criteria can include various portions of the sleeve 104. For example, an inner bore diameter D6 of the cylindrical base 114, an outside diameter of the cylindrical base D7, an outside diameter of the ribs D5, the angle 121 of the ramp portions 120 (shown in FIG. 6), the number of ribs 112, and other profile characteristics of the sleeve 104. The inner bore diameter D6 of the cylindrical inner bore 115 of the base 114 is generally defined by the inserting bolt 102 size and the diameter D1 of the retention portion 103 on the bolt 102. The outside diameter D7 of the cylindrical base 114 is defined by the bolt 102 size such that the sufficient interference is provided between the bolt features (e.g., threads 110, bolt head 108) and the sleeve 104 to ensure the sleeve 104 is retained in the retention portion 103 (i.e., cannot freely move along the complete length of the bolt shaft 105).

The ribs 112 create interference with the coupling aperture 109 where the bolt 102 is inserted. In at least some embodiments, the rib 112 outside diameter D5 is chosen by the amount of press-in force (insertion force) desired to insert the bolt 102 and sleeve 104 assembly in a coupling aperture 109 (generally a maximum value), and the amount of force required to remove the bolt 102 and sleeve 104 assembly from the coupling aperture 109 (removal force) (generally a minimum value). In application, the maximum force required to insert the bolt retention device 100 and the minimum force required to remove the bolt retention device 100 is defined. The shape and width of the ribs 112 along with their outside diameter can create a compounding effect to increase the gap between these required opposing forces. The number of ribs 112 can be defined based on minimum force that the bolt retention device 100 needs to resist without being removed from the coupling aperture 109 and the amount of length available on the inner coupling aperture surface 111 where such interference between the sleeve 104 and the inner coupling aperture surface 111 can be created.

Referring to FIG. 7, cross-section of a portion of the sleeve 104 is depicted comprising exemplary ribs 122, 126, 128, each with an individual shape profile, all with different characteristics and purposes. The first rib 122 is shown with a comparatively gradual ramp portion 120 followed by a shear face 124. This rib 122 allows for easy initial installation of the bolt 102 and sleeve 104 assembly into the coupling aperture 109 of the component 107 but provides comparatively high resistance to its removal. The second rib 126 has a steeper ramp portion 120 with a larger maximum diameter that would provide greater resistance to insertion compared to the first rib 122, but comparatively similar resistance to removal due to its shear face 124. Lastly, the third rib 128 includes a non-linear ramp portion 120, but is substantially symmetrical in the axial direction, providing substantially symmetrical resistive properties during both insertion and removal. The particular characteristics of this substantially symmetrical third rib 128 will vary greatly depend on the thickness of the third rib 128 and the material properties of the sleeve 104. For example, the third rib 128 could be made thin enough or from pliable enough material to flex easily in both directions and used for indexing purposes, providing tactile or even auditory feedback to a user to indicate how far a bolt 102 has been inserted into a coupling aperture 109. It also could be made wider or with less pliable material and used as a backstop, preventing the bolt 102 from being inserted any further into a coupling aperture 109.

Referring to FIGS. 8-11, two other exemplary embodiments of a sleeve 204, 304 are shown that can in at least some embodiments, engage the retention portion 103 similarly to sleeve 104. FIG. 8 depicts the sleeve 204 in a perspective view, having a plurality of ribs 212 extending radially from a cylindrical base 214, while FIG. 9 is a partial close-up view of the sleeve 204 taken at line 9-9 in FIG. 8. As shown in the figures, in at least some embodiments, the sleeve 204 further comprises a ring portion 230 following each ramp portion 220. The ring portion 230 can be shaped as a flat section of a rib 212 that has a constant radial diameter as it extends longitudinally. In at least some embodiments, the diameter is selected to be large enough to provide constant resistive force during insertion or removal of the bolt 102. A rib 212 with this particular shape can provide increased resistance to impact forces by requiring a consistent application of force over a longer period of time to move the ribs 212 past the coupling aperture 109, in comparison to a ramp portion followed immediately by a shear face (e.g., the ribs 112 of sleeve 104).

FIGS. 10 and 11 depict yet another exemplary embodiment of a sleeve 304 that includes a plurality of ribs, such ribs, 311, 312, 313, extending from a cylindrical base 314 and a plurality of longitudinally extending slats 332 that can interconnect two or more of the ribs. As shown, the bottom of a leading rib (e.g., 311) can be connected to the top of the trailing rib (e.g. 312), as discussed in detail below. For clarity, a trailing rib is considered a rib situated behind another rib, where that other rib is then considered a leading rib.

In at least some embodiments, the slats extend 332 between ring portions 330 of the ribs and can be coplanar therewith. As a removal force is applied to the bolt retention device secured in a coupling aperture 109, the leading rib 312 flexes and deflects in a direction opposite of the force. This deflection translates into axial movement of the slat 332 from the bottom of the leading rib 312 to the top of the trailing rib. As the trailing rib is pushed subject to a removal force, its outer diameter increases as the ring portion 330 flexes outwards (longitudinal deflection is limited by the slats 332). As such, the retention ability and incremental removal force required is increased due to the outward expansion of the trailing ribs due to the interconnected slats creating increased interference. The slat 332 design can vary in shape, connection location between the ribs, number of slats 332, width, and thickness. The connection location of the slats 332 along the ribs can define the amount of radial movement of a trailing ring when the leading rib flexes. The shape, width and thickness of the slats 332 can determine the amount of movement translated from the leading rib to the trailing rib. The number of slats 332 can determine the amount and consistency of increased outer diameter of the trailing rib.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A bolt retention device comprising:
a bolt having a shaft;
a retention portion of the shaft that includes a radial retention surface;
a sleeve having a cylindrical base with an inner bore; and
at least one rib extending radially from the cylindrical base, wherein the retention portion of the shaft has a diameter sized to receive the inner bore of the sleeve, and wherein the bolt is inserted into the sleeve to align the retention portion with the inner bore of the sleeve.

2. The bolt retention device of claim 1, wherein the sleeve is expandable and configured to allow the sleeve to fit over a bolt feature.

3. The bolt retention device of claim 2, wherein the sleeve further comprises a gap extending longitudinally.

4. The bolt retention device of claim 3, wherein the gap spans a length extending between a first end and a second end of the sleeve.

5. The bolt retention device of claim 3, wherein the gap partially spans a length extending between a first end and a second end of the sleeve.

6. The bolt retention device of claim 1, wherein the at least one rib includes two or more ribs.

7. The bolt retention device of claim 1, wherein the sleeve is formed from a pliable material.

8. The bolt retention device of claim 1, wherein the rib further comprises a ramp portion.

9. The bolt retention device of claim 8, wherein the ramp portion extends linearly.

10. The bolt retention device of claim 8, wherein the ramp portion extends non-linearly.

11. The bolt retention device of claim 1, wherein the rib further comprises a shear face.

12. The bolt retention device of claim 1, wherein the rib further comprises a ring portion.

13. The bolt retention device of claim 1, wherein the diameter of the retention portion is less than an inner thread diameter of the bolt.

14. The bolt retention device of claim 1, wherein the sleeve further comprises an indexing member configured to provide tactile feedback to a user during installation of the bolt to limit over-insertion of the bolt into a coupling aperture of a component.

15. The bolt retention device of claim 1, wherein the sleeve further comprises a backstop at an end, sized and positioned to prevent the bolt from being further inserted into a coupling aperture of a component.

16. The bolt retention device of claim 15, wherein the backstop is made from a material having a greater rigidity than the material used to form the rest of the sleeve.

17. The bolt retention device of claim 6, wherein at least one of the two or more ribs is shaped differently from another of the two or more ribs.

18. The bolt retention device of claim 6, further comprising one or more longitudinal slats extending radially from the base that interconnect two or more of the two or more ribs.

19. The bolt retention device of claim 18, wherein the two or more ribs include a leading rib and a trailing rib, and wherein at least one of the one or more longitudinal slats is connected to the bottom of the leading rib and the top of the trailing rib.

20. A bolt retention device comprising:
a bolt having a bolt head and a shaft including threads;
a retention portion formed along the shaft; and
a sleeve insertable over the shaft of the bolt to rest at least partially on the retention portion of the bolt, the sleeve further comprising:
a first rib with a gradual linear ramp portion;
a second rib with a steep linear ramp portion;
a third rib with a non-linear ramp portion; and
a gap in the axial direction configured to allow the sleeve to deform and expand outwardly when under force, wherein the first rib and second rib are separated from one another by a portion of constant sleeve diameter, and the second rib and the third rib are separated from one another by a portion of constant sleeve diameter, and wherein the sleeve is insertable into a coupling aperture of a component and that the first rib, the second rib, and the third rib provide a resistive force when a removal force is applied to the bolt.
